(19) United States
(12) Patent Application Publication
(10) Pub. No.: US 2020/0180151 A1
(43) Pub. Date: Jun. 11, 2020

(54) SYSTEM AND METHOD FOR CONTROLLING JERK ASSOCIATED WITH ONE OR MORE ROBOTIC JOINTS

(71) Applicant: Teradyne, Inc., North Reading, MA (US)

(72) Inventors: Tyler Randolph Ryan, Bloomington, MN (US); James D. English, Alva, FL (US)

(21) Appl. No.: 16/210,573

(22) Filed: Dec. 5, 2018

(51) Int. Cl. B25J 9/16

(52) U.S. Cl. CPC B25J 9/1641; B25J 9/1664

(57) ABSTRACT

Embodiments included herein may be configured for controlling jerk on one or more robotic joints of a robot. Embodiments may include calculating a first path to be traveled by a robot without applying one or more jerk restrictions. One or more jerk restrictions may be applied to the first path after the first path has been calculated to generate a second path.

### TECHNICAL FIELD

The present disclosure relates to controlling jerk on one or more robotic joints, and more specifically, to a system and method for controlling jerk on one or more robotic joints of a robot during motion.

### BACKGROUND

Many CAD (computer-aided design) software packages support design, such as SOLID WORKS, UG NX, and PRO/ENGINEER. Also many packages provide analysis, such as WORKSPACES, DARVIM 2K, and ADAMS. Yet design and analysis packages rarely work together well to meet the specific needs of robot designers. For maximum efficiency, a robot designer might want to modify a hardware design and test it in software 10-20 times in a workday. Yet modifying a robot design on one software package, then converting and validating it on another can take days of effort, and when finished, the designer may not have access to the information really needed for robot analysis, such as control torques and sensor data. This inefficiency is expensive and time consuming, and it is detrimental to the quality of robot designs.

New ways for connecting the existing well-solved pieces of the robot design cycle as well as new robot-specific analysis are needed. Constructing a part in a CAD program is largely solved. Simulating rigid-body dynamics with differential equations is largely solved. A challenge lies in connecting these and other components and integrating human input in an efficient way.

Another challenge lies in adding all the capability needed by roboticists. Most commercial packages are not tailored to robotics. To make a complete product that will find wide acceptance and use, new algorithms and software should support robotic workspace, control, manipulation, sensor, actuator, and locomotion analysis. The human interface should provide robotics-tailored data, described using robotic terminology. A new software framework that integrates commercial capability where available and adds new capability where needed may change the nature of development for the entire robotics field.

### SUMMARY

In one embodiment of the present disclosure, a computer-implemented method for controlling jerk on one or more robotic joints of a robot during motion may include calculating a first path to be traveled by a robot without applying one or more jerk restrictions. One or more jerk restrictions may be applied to the first path after the first path has been calculated to generate a second path.

One or more of the following features may be included. The second path may be configured to move an end effector or a tool of the robot along the second path in a velocity in less than a predetermined value. The first path may be based upon, at least in part, a path time parameter. The predetermined value may be defined by a user. The first path may be generated in real time over one or more timesteps by considering at least one of velocity, acceleration, robotic arm link configuration, one or more obstacles in the environment, and energy consumption. The first path may be generated in real time by including at least one constraint on point position, frame orientation, pointing direction, center of mass position, or linear or angular momentum. The one or more jerk restrictions may include a jerk value below a predetermined value. A stop profile may be calculated and tested after the second path is generated. The one or more jerk restrictions may be configured to prevent vibration of one or more robotic joints or an end effector of a robot. One or more robotic joints may be part of robotic hardware, wherein the robotic hardware may be at least one of a mobile robot, a fixed base articulated serial manipulator, a moving base articulated serial manipulator, a fixed base articulated robot with branching links, and a moving base articulated robot with branching links.

In another embodiment of the present disclosure, a computing system including a processor and a memory system may be configured to perform operations including calculating a first path to be traveled by a robot without applying or more jerk restrictions. One or more jerk restrictions may be applied to the first path after the first path has been calculated to generate a second path.

One or more of the following features may be included. The second path may be configured to move an end effector or a tool of the robot along the second path in a velocity less than a predetermined value. The first path may be based upon, at least in part, a path time parameter. The predetermined value may be defined by a user. The first path may be generated in real time by including at least one constraint on point position, frame orientation, pointing direction, center of mass position, or linear or angular momentum. The one or more jerk restrictions may include a jerk value below a predetermined value. A stop profile may be calculated and tested after the second path is generated. The one or more jerk restrictions may be configured to prevent vibration of one or more robotic joints or an end effector of a robot. One or more robotic joints may be part of robotic hardware, wherein the robotic hardware may be at least one of a mobile robot, a fixed base articulated serial manipulator, a moving base articulated serial manipulator, a fixed base articulated robot with branching links, and a moving base articulated robot with branching links.

In another embodiment of the present disclosure, a computer implemented product comprising a non-transitory computer readable storage medium having a plurality of instructions stored thereon, which, when executed by a processor, may cause the processor to perform operations including calculating a first path to be traveled by a robot without applying one or more jerk restrictions. One or more jerks restrictions may be applied to the first path after the first path has been calculated to generate a second path.

One or more of the following features may be included. The second path may be configured to move an end effector or a tool of the robot along the second path in a velocity less than a predetermined value. The first path may be based upon, at least in part, a path time parameter. The predetermined value may be defined by a user. The first path may be generated in real time by including at least one constraint on point position, frame orientation, pointing direction, center of mass position, or linear or angular momentum. The one or more jerk restrictions may include a jerk value below a predetermined value. A stop profile may be calculated and tested after the second path is generated. The one or more jerk restrictions may be configured to prevent vibration of one or more robotic joints or an end effector of a robot. One or more robotic joints may be part of robotic hardware, wherein the robotic hardware may be at least one of a mobile robot, a fixed base articulated serial manipulator, a moving base articulated serial manipulator, a fixed base articulated robot with branching links, and a moving base articulated robot with branching links.

The details of one or more example embodiments are set forth in the accompanying drawings and the description below. Other possible example features and/or possible example advantages will become apparent from the description, the drawings, and the claims. Some embodiments may not have those possible example features and/or possible example advantages, and such possible example features and/or possible example advantages may not necessarily be required of some embodiments.

### BRIEF DESCRIPTION OF THE DRAWINGS

For a better understanding of the nature and objects of the present invention, reference is made to the following detailed description taken in conjunction with the following drawings, in which:

FIG. 1 is a diagram depicting an embodiment of a system in accordance with the present disclosure;

FIG. 2 is a block diagram of robotic validation system for a robot design, according to an embodiment of the present disclosure;

FIG. 3 is a flow chart of a robotic validation system for a robot design, according to an embodiment of the present disclosure;

FIG. 4 is a flow chart of a system and method for controlling jerk on one or more robotic joints within a robotic validation system, according to an embodiment of the present disclosure;

FIG. 5 is a block diagram of a robotic validation system for a robot design for multiple client nodes using network connections, according to an embodiment of the present disclosure;

FIG. 6a is a block diagram representing a tree structure for a robot link's physical extent, according to an embodiment of the present disclosure;

FIG. 6b are pictures of basic shapes which can be applied, according to embodiments of the present disclosure;

FIG. 6c is a schematic representation of a string-to-surface-property map, according to an embodiment of the present disclosure;

FIG. 7 is a schematic representation of a link for constructing a robotic description, according to an embodiment of the present disclosure;

FIG. 8 is a schematic representation of a manipulator constructed by connecting links in a tree structure, according to an embodiment of the present disclosure;

FIG. 9 is a schematic representation of a stated system as a combination of a state and a system, according to an embodiment of the present disclosure;

FIG. 10a is a simple form of input to the parametric study which utilizes a reference stated system, control system and run time, according to an embodiment of the present disclosure;

FIG. 10b is a comprehensive form of input to the parametric study which uses any number of system changes combined with any number of state, placement and run-time changes, according to an embodiment of the present disclosure;

FIG. 11 is a schematic diagram of an architecture supporting peer-to-peer organization for the network embodiment of embodiments of the present disclosure;

FIG. 12 is a schematic representation of a network embodiment, wherein each client maintains both primary LAN routing node and a primary WAN routing node, according to an embodiment of the present disclosure;

FIG. 13a is a schematic representation of a terrain simulation, according to an embodiment of the present disclosure; and

FIG. 13b is a schematic representation demonstrating the radius of influence method for terrain-robot interaction modeling, according to an embodiment of the present disclosure.

### DETAILED DESCRIPTION

Embodiments included herein are directed towards a new software framework that does not require all geometric path information of a path to be traveled (i.e. path time, path distance, path velocity) by a robot in advance. Additional information related to this application may be found in U.S. Pat. No. 8,301,421 and U.S. Patent Pub. No. 2010/0152899, which are hereby incorporated by reference herein in their entirety. Embodiments included herein may allow for the control of velocity, acceleration, and/or jerk of one or more robotic joints of a robot.

According to a first aspect of the invention, a method for generating a validation system to validate a robot design of a robotic system may comprise the steps of: automatically converting a robot design into a generic robotic description using a predetermined format; automatically generating a control system from the generic robotic description; and updating robot design parameters of a robotic system with an analysis tool using the generic robotic description and the control system.

According further to the first aspect of the invention, the updating of robot design parameters may be automatic.

Further according to the first aspect of the invention, the robot design may be loaded from robot design software.

Still further according to the first aspect of the invention, the robot design may comprise at least one of: a) a hardware design, b) an electronic design, and b) surface properties.

According further to the first aspect of the invention, the analysis tool may provide a simulation and the simulation may be at least one of: a) a kinematic simulation, b) a dynamic simulation, c) a terrain simulation.

According still further to the first aspect of the invention, the predetermined format may be at least one of: a) an extensible markup language (XML), and b) a text based format.

According further still to the first aspect of the invention, the robotic description may comprise at least one of: a) a model of the environment, and b) sensor models.

According yet further still to the first aspect of the invention, the control system may comprise at least one of: a) a kinematic component, b) a dynamic component, c) an adaptation feature for avoiding self-collisions and collisions with the environment, and d) an adaptation feature to control deforming links and avoid collisions with the deforming links.

Yet still further according to the first aspect of the invention, the robotic system may comprise at least one feature out of: a) one or more articulated manipulators with one or more rigid or deforming links having a fixed base, b) one or more articulated mobile mechanisms with one or more rigid or deforming links, c) a bifurcating kinematic structure, and d) a closed kinematic structure.

Still yet further according to the first aspect of the invention, the generating the robotic validation may be provided using at least one of: a) network communications, and b) network communications over Internet.

Still further still according to the first aspect of the invention, the robotic system may be controlled using at least one of: a) network communications; and b) network communications over Internet.

According further still to the first aspect of the invention, the control system may be established using at least one of: a) network communications; and b) network communications over Internet.

According yet further still to the first aspect of the invention, the robotic system may be used for at least one application out of: a) space applications, b) military applications, c) agricultural applications, d) medical applications, e) domestic applications, f) mining applications, and g) agricultural applications.

According still yet further still to the first aspect of the invention, the updating robot design parameters may comprise calculating updated robotic parameters by the analysis tool using at least one of: a) Monte Carlo analysis, b) parametric analysis, and c) parameter-optimization analysis. Further, the updating robot design parameters may comprise using automatically the updated robotic parameters calculated by the analysis tool to improve the design of the robotic system by the design tool. Still further, the updated robotic parameters may be provided to a design tool for improving the design of the robotic system by the design tool.

Yet still further according to the first aspect of the invention, the general robotic description may comprise at least one of the following features: a) shapes, b) links, c) manipulators, d) stated systems, e) mechanisms with generic joint articulation comprising sliding, rotational, elliptical, or spherical articulations, and f) automatic simplification of the hardware design comprising physical dimensions, surface properties, kinematics properties or dynamics properties. For example, the links of the general robotic description may comprise a robotic arm.

Further, the robotic arm may be composed of multiple links jointed together by multiple joints. In this example, dynamics of the robotic arm, which may comprise a robot, may be modeled by the robotic arm's (or the robot's) kinematics. Each link of the robotic arm (or robot) may be a rigid body/variable. If there are multiple links, the robotic arm (or robot) may include variables that may be described with a vector. Constraints may be imposed on at least one of all or a subset of the variables, multiple links, and vector components. As a result of imposing the constraints on the at least one of all or a subset of the variables, multiple links, and vector components, one or more paths for a robotic arm (or robot) to travel may be calculated as a vector. Specifically, that path may be calculated for all components of the vector, multiple links, and variables that may include any individual link's movement trajectory, end effector or handling tool's path trajectory. Additionally, in this example, jerk constraints may be imposed on the one or more paths calculated. For example, jerk constraints may be imposed on an end effector or handling tool of the robotic arm.

Still yet further according to the first aspect of the invention, the control system may use Jacobian-based algorithm. Further, the control system may use a velocity-control framework using the following algorithm:

V=J(q)\dot{q}* (1)

wherein V is an m-length vector representing a motion of end effectors; q is a vector of joint positions, \dot{q}* is an n-length vector formed by augmenting a derivative vector \dot{q}* with linear and angular velocities of a base link of the robotic system; and J is an m×n Jacobian as a function of q, wherein

$${\dot{q}}^{*} = {[ \frac{J}{{N}_{J}^{T} W} ]}^{- 1} [ \frac{V}{- α {N}_{J}^{T} F} ] . \qquad ( 2 )$$

wherein N_{J} is an n×(n−m) set of vectors that spans a null space of J, α is a scalar, W(q) is a matrix function, and F(q) is a vector function.

According to the first aspect of the invention, the control system may use a joint jerk limiting framework to control jerk on one or more robotic joints of a robot during motion. The joint jerk limiting framework may be used in combination with the velocity-control framework or without the velocity-control framework.

According to a second aspect of the invention, a computer program product comprising: a computer readable storage structure embodying computer program code thereon for execution by a computer processor with the computer program code, characterized in that it includes instructions for performing the steps of the first aspect of the invention, indicated as being performed by any component of a robotic validation system for a robot design of a robotic system.

According to a third aspect of the invention, a robotic validation system for a robot design of a robotic system performed automatically, comprises: a design software interpreter, for converting the robot design into a generic robotic description using a predetermined format, and for generating a control system from the generic robotic description; and an analysis tool, for updating robot design parameters of the robotic system using the generic robotic description and the control system.

According further to the third aspect of the invention, the design software interpreter may be a client node of a network.

Further according to the third aspect of the invention, the robotic validation system for a robot design of a robotic system may comprise an analysis software interpreter, for converting the generic robotic description to a native format of the analysis tool. Further, the analysis software interpreter may be a client node of a network.

Still further according to the third aspect of the invention, the robotic validation system for a robot design of a robotic system may comprise a design tool, for reading a file describing the robot design in a native format for converting the robot design to the generic robotic description using the predetermined format. Further, the robotic validation system may comprise a Post-processing tool, for writing results of the updating robot design parameters to improve the design of the robotic system by the design tool.

A new method, system and computer program are presented for generating a robotic validation system for a robot design. According to an embodiment of the present invention, the validation system for a robot design (of a robotic system) may be automatically generated by converting a robot design into a generic robotic description using a predetermined format, then a control system may be generated from the generic robotic description and finally updating robot design parameters of the robotic system with an analysis tool using both the generic robotic description and the control system. There are many variation and embodiment options according to embodiments of the present invention. These embodiments are provided below.

The robot design may be loaded, e.g., from robot design software. The robot design may comprise hardware design, electronic design, and/or surface properties. Surface properties may be defined by an appearance and/or mechanical properties of the surfaces. For example, surface properties may be (but are not limited to) any generic information like color, transparency, shininess, spring constant for defining stiffness, hardness, flexibility, fragility, friction properties, etc. The robotic description may comprise (but is not limited to) a model of the environment and/or sensor models (e.g., for providing a force feedback to assist with grasping objects), such as touch sensors, force sensors, joint encoders, accelerometers, gyroscopic sensors, color cameras, gray-level cameras, ladar, or hyperspectral sensors.

The robotic system may be used (but is not limited to): space applications, military applications, agricultural applications, domestic applications, mining applications, medical applications, etc. The robotic system may comprise the following features:

a) one or more articulated manipulators with one or more rigid (in general, links may be perfectly rigid, i.e., no bending, growing, shrinking, etc.) or deforming links (deforming links, designed to change shape in a controllable way, are not rigid bodies and typically have more degrees of freedom than rigid bodies, e.g., more than 6 degrees of freedom) having a fixed base (fixed based robots are often seen in manufacturing wherein, e.g., an arm may be attached to a fixed base which cannot move, whereas mobile robots may be on mobile platforms often on wheels, legs, or tracks);
b) one or more articulated mobile mechanisms with one or more rigid or deforming links, and/or
c) a bifurcating kinematic structure.

The general robotic description may comprise (but is not limited to) the following features: shapes, links, manipulators, stated systems, mechanisms with generic joint articulation comprising sliding, rotational, elliptical, or spherical articulations, and/or automatic simplification of the hardware design comprising physical dimensions, surface properties, kinematics properties or dynamics properties.

The control system may be automatically generated from the robotic description. The control system may comprise (but may not be limited to): a kinematic component, a dynamic component, an adaptation feature for avoiding self-collisions and collisions with the environment, and an adaptation feature to control deforming links and provide collision avoidance with deforming links.

The predetermined format may be generally text based and can use, e.g., an extensible markup language (XML). The network communications (e.g., over Internet) may be used for generating the robotic validation, for controlling the robotic system, and/or for establishing the control system.

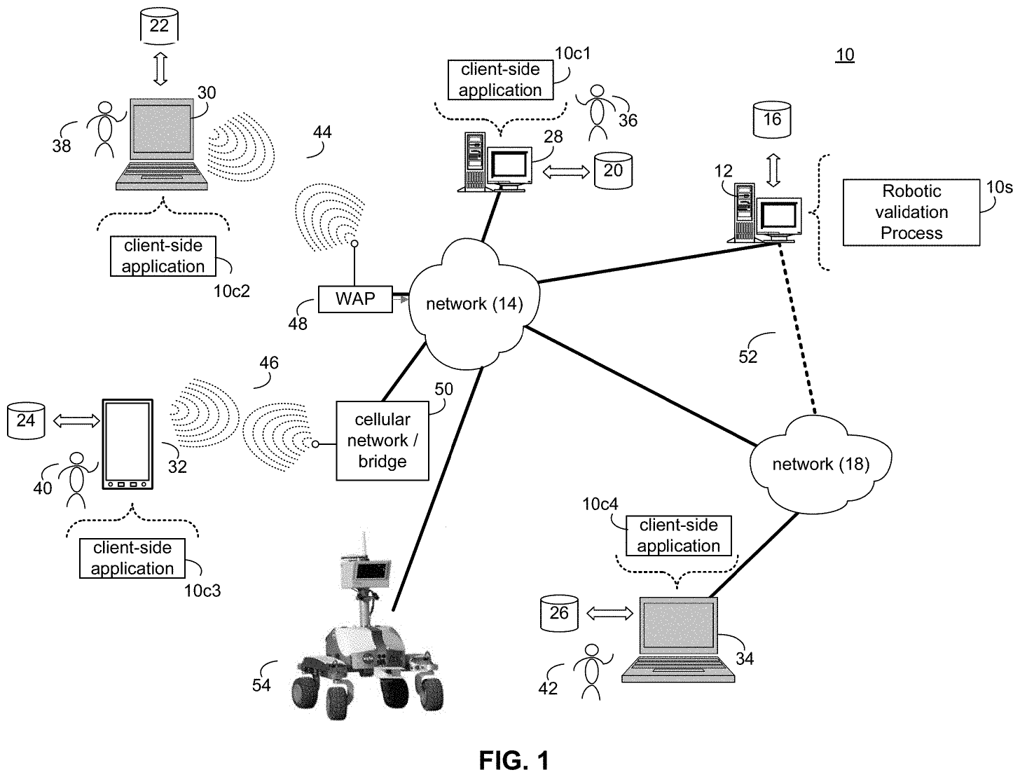

Specifically, referring to FIG. 1, there is shown a process for generating a robotic validation system for a robot design 10 (hereinafter “robotic validation process 10”). For the following discussion, it is intended to be understood that robotic validation process 10 may be implemented in a variety of ways. For example, robotic validation process 10 may be implemented as a server-side process, a client-side process, or a hybrid server-side/client-side process.

For example, robotic validation process 10 may be implemented as a purely server-side process via robotic validation process 10s. Alternatively, robotic validation process 10 may be implemented as a purely client-side process via one or more of client-side application 10c1, client-side application 10c2, client-side application 10c3, and client-side application 10c4. Alternatively still, robotic validation process 10 may be implemented as a server-side/client-side process via screen robotic validation process 10s in combination with one or more of client-side application 10c1, client-side application 10c2, client-side application 10c3, and client-side application 10c4. In such an example, at least a portion of the functionality of robotic validation process 10 may be performed by robotic validation process 10s and at least a portion of the functionality of robotic validation process 10 may be performed by one or more of client-side application 10c1, 10c2, 10c3, and 10c4.

Accordingly, robotic validation process 10 as used in disclosure may include any combination of robotic validation process 10s, client-side application 10c1, client-side application 10c2, client-side application 10c3, and client-side application 10c4.

Robotic validation process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of robotic validation process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to an application incorporated into and executed within a client-side process incorporated into and executed with a client-side media applications, a web browser, media decoder, such as, audio and video decoders. It is understood that the aforementioned may be incorporated into a mobile device platform. The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, personal computer 28, laptop computer 30, mobile computing device 32, notebook computer 34, a netbook computer (not shown), a server computer (not shown), a gaming console (not shown), a data-enabled television console (not shown), and a dedicated network device (not shown). Client electronic devices 28, 30, 32, 34 may each execute an operating system.

Users 36, 38, 40, 42 may access robotic validation process 10 directly through network 14 or through secondary network 18. Further, robotic validation process 10 may be accessed through secondary network 18 via link line 52. Robotic validation process 10 may access a robotic device (e.g., robotic device 54) through network 14 by one or more of the users (e.g., Users 36, 38, 40, 42).

The various client electronic devices (e.g., client electronic devices 28, 30, 32, 34) may be directly or indirectly coupled to network 14 (or network 18). For example, personal computer 28 is shown directly coupled to network 14. Further, laptop computer 30 is shown wirelessly coupled to network 14 via wireless communication channels 44 established between laptop computer 30 and wireless access point (WAP) 48. Similarly, mobile computing device 32 is shown wirelessly coupled to network 14 via wireless communication channel 46 established between mobile computing device 32 and cellular network/bridge 50, which is shown directly coupled to network 14. WAP 48 may be, for example, an IEEE 802.11a, 802.11b, 802.11g, 802.11n, Wi-Fi, and/or Bluetooth device that is capable of establishing wireless communication channel 46 between laptop computer 30 and WAP 48. Additionally, personal computer 34 is shown directly coupled to network 18 via a hardwired network connection.

In some embodiments, robotic validation process 10 may provide a simulation which can (but is not limited to) kinematic simulation, dynamic simulation, and/or terrain simulation. In some embodiments, the updating of robot design parameters may comprise calculating updated robotic parameters by the analysis tool using (but not be limited to) the following methods: Monte Carlo analysis, parametric analysis, and/or parameter optimization control. In some embodiments, the updating of robot design parameters may comprise using automatically the updated robotic parameters calculated by the analysis tool to improve the design of the robotic system by the design tool. In some embodiments, the updated robotic parameters may be provided to a design tool for improving the design of the robotic system by the design tool.

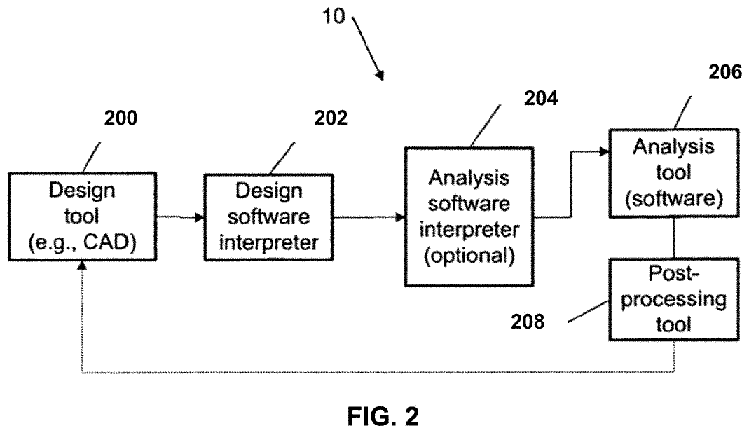

FIG. 2 is an example among others of a block diagram of a simplified robotic validation system 10 for a robot design, according to an embodiment of the present invention. The example of FIG. 2 may be implemented, e.g., on one computer. The design tool 200 may be CAD software represented, e.g., in SOLID WORKS. The CAD software (the block 200) may read a file describing a robot design in its proprietary format.

In response to an appropriate command from the user, the design software interpreter 202 may convert the file describing a robot design (e.g., a CAD hardware design) into a specific robotic description using a predetermined format, e.g., extensible markup language (XML). Typically, the design software interpreter 202 may be plugged into the CAD software at load time (e.g., component object model (COM) or dynamic link library (DLL) linking may be used to accomplish this integration). Because it may be plugged in at run-time, the interpreter 202 may use the calling methods of the design tool 200 (e.g., the CAD software) to get the hardware design. Along with the specific robotic description (e.g., an XML file with a conversion of the CAD hardware design), a new control system (also, e.g., in the XML) for controlling the robot and appropriate for the robot design may be created by the interpreter 202. The user may also specify the type of analysis/simulation (e.g., the parameter optimization, Monte Carlo simulation, parameter optimization study, kinematic simulation, dynamic simulation, and/or dynamic simulation, etc.) to be performed, typically after being prompted by the interpreter 202.

Moreover, if the analysis tool 206 cannot read the predetermined format (e.g., XML) directly, an analysis software interpreter 204 may convert the generic robotic description (e.g., in XML) to its native format. The analysis tool 206 may then perform the analysis specified by the user with the results being fed back to the design tool 200 (e.g., using the interpreter 202). Alternatively, the analysis tool 206 may write out results to the native format of a post-processing tool 208. Then the post-processing tool 208 may write results in the XML which may be read by the design software interpreter 204 subsequently updating the CAD model of the robot design by using the calling methods of the design tool 200.

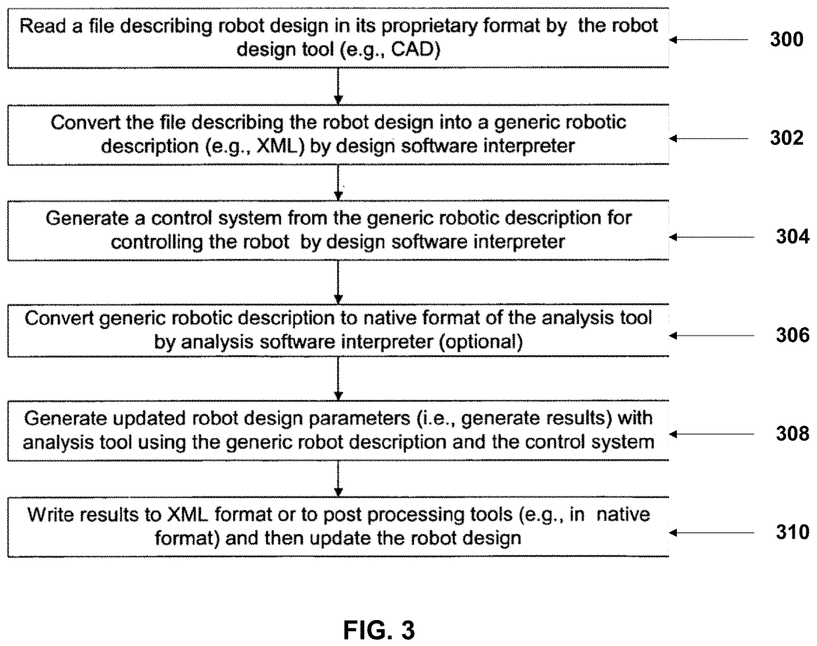

FIG. 3 is a flow chart of a robotic validation system 10 for a robot design, according to an embodiment of the present invention. The flow chart of FIG. 3 only represents one possible scenario among others. In a method according to the first embodiment of the present invention, in a first step 300, the robot design tool (e.g., CAD) 200 may read the file describing the robot design of the robotic system in its proprietary format. In a next step 302, the design software interpreter 202 may convert the file describing the robot design into a generic robotic description (e.g., XML). In a next step 304, subsequently, the design software interpreter 202 may also generate a control system from the generic robotic description for controlling the robot (e.g., also in XML).

Moreover, in a next step 306, the analysis software interpreter 204, if necessary, may convert the generic robotic description to a native format of the analysis tool 206. In a next step 308, the analysis tool 206 may generate updated robot design parameters (i.e., generates results) using the generic robotic description and the control system provided by the design software interpreter 202. Finally, in a next step 310, results generated by analysis tool 206 may be written to the XML format or to a post processing tool (e.g., in the native format) subsequently updating the CAD model of the robot design by the design tool 200.

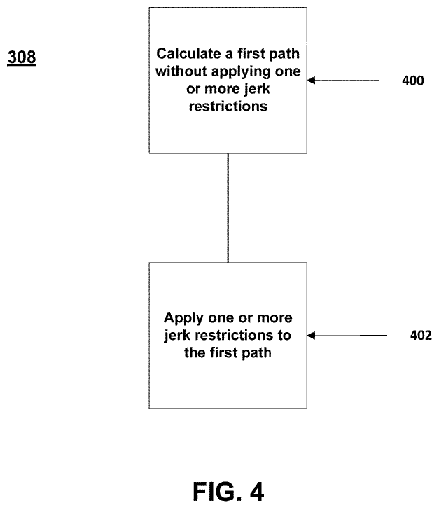

FIG. 4 is a flow chart of a system and method for controlling jerk on one or more robotic joints within the robotic validation system, according to an embodiment of the present invention. In step 308, as show in FIG. 3, the analysis tool 206 may generate updated robot design parameters (i.e., generates results) using the generic robotic description and the control system provided by the design software interpreter 202. To generate the updated robot design parameters, a first path of the robot may be calculated 400 without applying one or more jerk restrictions. One or more jerk restrictions may be applied 402 to the first path.

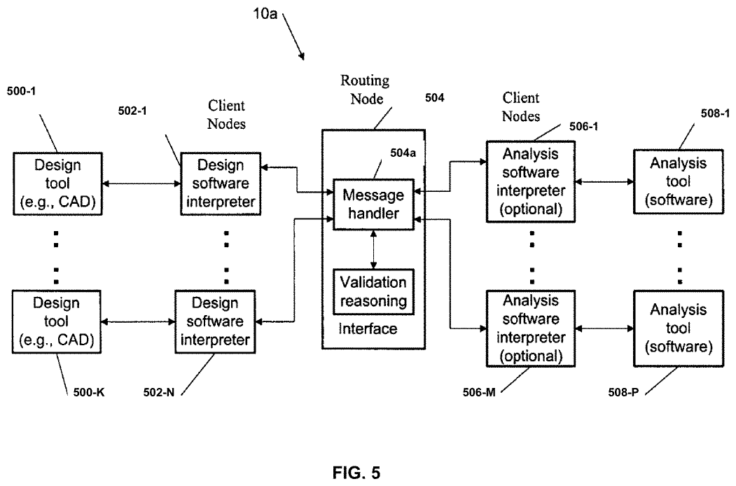

FIG. 5 shows an example among others of a robotic validation system 10a for a robot design for multiple client nodes using network connections, according to an embodiment of the present invention. The robotic validation system 10a (or the design-and-validation system) may be organized using client and routing nodes that exchange information on robot design and analysis results over networked or direct connections. There may be two possible groups of client nodes. One group may comprise N design software interpreters 502-1, 502-2, . . . , 502-N. Each of these interpreters 502-1, 502-2, . . . , 502-N may have similar functionality as the block 202 of FIG. 2. Another (optional) node group may comprise M analysis software interpreters 506-1, 506-2, . . . , 506-M. Each of these interpreters 506-1, 506-2, . . . , 506-M may have similar functionality as the block 206 in FIG. 2. The routing node (interface) 504 may have a message handler 504a which provides a network communication (e.g., through the Internet) between any of the client nodes 502-1, 502-2, . . . 502-N and any of the client nodes 506-1, 506-2, . . . , 506-M. The validation reasoning block may represent software that ensures the validity of all exchanged messages, using, e.g., an XML schema. The system 10a may have K design tools 500-1, 500-2, . . . , 500-K (e.g., installed on K network computers) and P analysis tools 508-1, 508-2, . . . , 508-P (e.g., installed on P network computers), wherein each of these blocks may have the same functionally as blocks 200 and 206, respectively, in FIG. 2. Each of the K design tools 500-1, 500-2, . . . , 500-K may use services of any or pre-selected design software interpreters from the N design software interpreters 502-1, 502-2, . . . , 502-N for translating to/from the predetermined format (e.g., XML). Similarly, each of the P analysis tools 508-1, 508-2, . . . , 508-P may use services of any or pre-selected design software interpreters from the M analysis software interpreters 506-1, 506-2, . . . , 506-M for translating to/from the predetermined format (e.g., XML). It is noted that K, N, M and P may be integers, which may have different values or a combination thereof may have the same values.

Direct interfaces to design and validation software may be made through client nodes, and connections between design and validation software may be made through routing nodes. When the nodes are parts of a single application, the communication may typically be through a direct exchange of information in memory. However, when the nodes are parts of the network, the communication may be, e.g., through the XML over TCP/IP (transport control protocol/internet protocol) as illustrated in FIG. 5.

The performance of the system 10a may be similar to the performance of the system shown in FIG. 3. For example, the design software interpreter 502-1 may take the hardware design as contained in the CAD design software (i.e., the design tool 500-1) and convert it to the generic robotic description with a control system. The user may also specify the form of analysis to apply to the conversion (e.g., Monte Carlo simulation or other methods according to embodiments of the present invention). The routing node 504 may automatically send the data in the form of, e.g., XML to the computer with the analysis tool 18-1. If needed, the analysis software interpreter 506-1 may convert the XML to the format required by the analysis tool 508-1. The analysis tool 508-1 may perform the simulation and sends results back to the CAD design software for updating the CAD model of the robot design by the design tool 500-1.

Information passed from the design tool (e.g., 500-1, 500-2, . . . , or 500-K) to the analysis tool (e.g., 508-1, 508-2, . . . , 508-P) may be (but is not limited to): 1) a description only of the system, with the type of analysis left up to the analysis tool or 2) both a system and a request for a specific type of analysis. The potential forms of the data transmitted from the design to the analysis tool are given in Table I below.

TABLE 1

| Data Form | Description |
|---|---|
| Shape | Any shape, including sphere, ellipsoid, capsule, |
| | polyhedron, and so forth. |
| Link | A single link in a robotic mechanism, which |
| | includes the shape, kinematics, mass properties, |
| | and actuator properties. |
| Manipulator | A single robot, which includes any number of |
| | connected links. |
| Stated System | Any number of robots and their states. |
| Kinematic | A simulation of a stated system, which includes a |
| Simulation | stated system, visualization properties and a |
| | kinematic control system. |
| Dynamic | A simulation providing all the capability of a |
| Simulation | kinematic simulation, but with dynamic simulation |
| | of articulation, physical impacts, and motor control. |
| Parametric | A study that changes parameters in fixed steps and |
| Study | tabulates outcomes. |
| Monte | A study that randomly varies parameters and |
| Carlo Study | tabulates simulation outcomes. |
| Parameter | A study that finds parameters that optimize a |
| Optimization | specified function of simulation outcomes. |
| Study | |

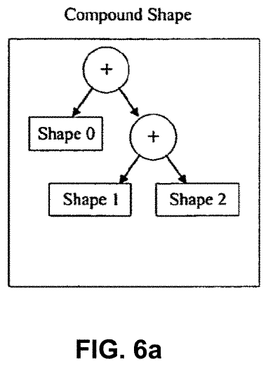

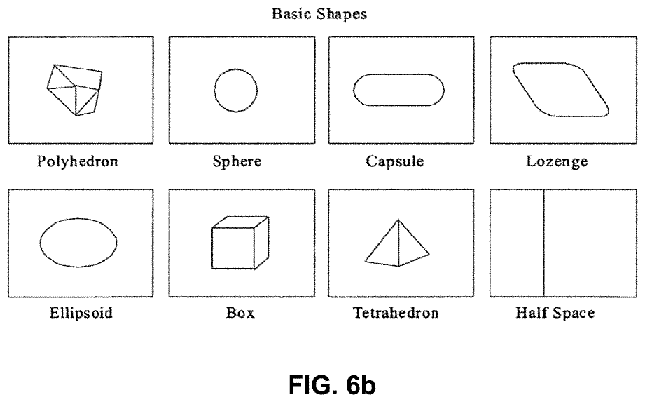

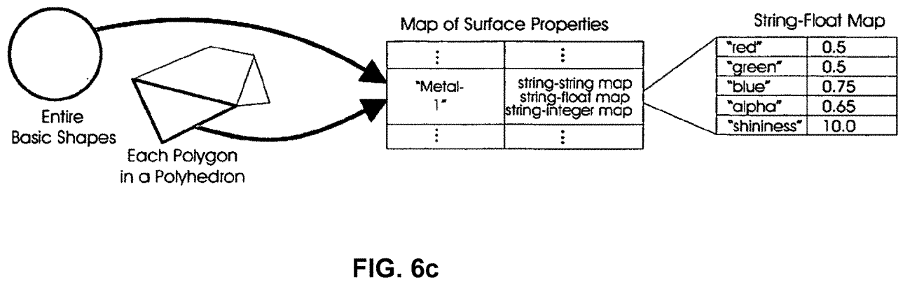

According to an embodiment of the present invention, a physical extent may be represented as a combination of geometric primitives through a tree structure shown in FIG. 6a. This tree structure may be used to represent a robot link's physical extent. Internal nodes may be unions or intersections, and the leaves are basic shapes. The most common shape may be the polyhedron. Other basic shapes may provide a simpler representation for some applications and serve as bounding volumes to speed up calculations. The tree structure may be composable at runtime, and may be easily modified (either directly or through the DLL) to support new geometric shape primitives or branching nodes. The leaves in the tree may be shape primitives, some examples of which are shown in FIG. 6b.

For rendering, simulation, and reasoning, every shape may use surface properties referenced by string tokens. Polyhedrons may organize their polygons by surface property. This is illustrated in FIG. 6c. Each shape (shown in FIG. 6b) may use a string-to-surface-property map. Each surface property in turn may maintain string-entity maps, including string-string, string-float, and string-integer maps. These may be configurable through the XML. They may represent virtually any property, including appearance, hardness, flexibility, fragility, and friction properties.

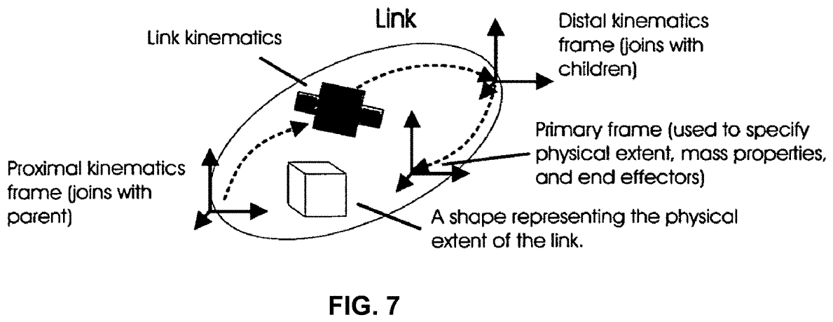

According to an embodiment of the present invention, the link may be the fundamental object used to construct robot descriptions. Each link may correspond to a single robotic joint. The distal frame of one link may be rigidly attached to the proximal frame of each child link in the kinematic structure. This may allow multiple formalisms such as, e.g., Paul or Craig's Denavit-Hartenberg (D-H) notation, and it may support the representation of new types of joints. Each link object, as illustrated in FIG. 7 may also hold mass properties, actuation parameters, the physical extent of the link, surface properties descriptions, and joint-limit dynamics (which is of the form shown in FIG. 6b). In FIG. 7, which represents a link, the proximal D-H frame may be rigidly attached to the parent. The distal D-H frame may align with the proximal D-H frame of child links.

The link's mass properties may include, e.g., up to 10 unique scalars needed for rigid-body dynamics calculations. These scalars may represent, for example, the mass, center of mass, and second moment of inertia. The actuator parameters may include (but are not limited to) the motor friction, motor inertia, gear ratio, and joint limits. Joint-limit dynamics may be represented using a repulsive force or torque that is proportional to the incursion into a specified zone defining the hard stop.

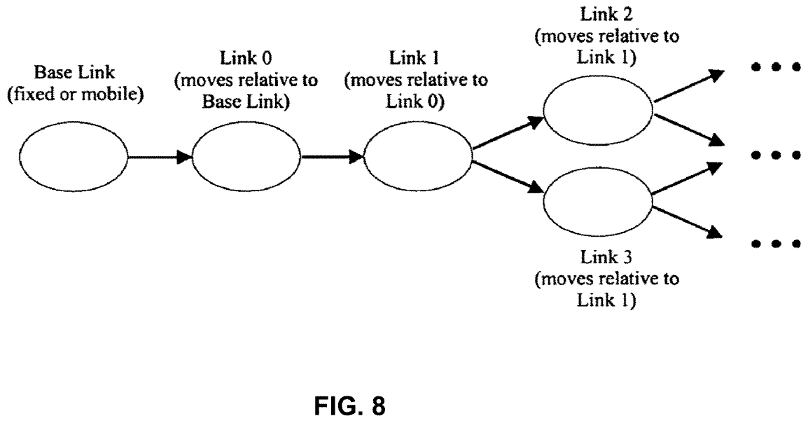

According to an embodiment of the present invention, a manipulator or robot may be constructed by connecting links in a tree structure, as shown in FIG. 8. The structure may support any number of links and any number of bifurcations, such as those present on LEMUR (legged excursion mechanical utility rover, see, e.g., T. Bretl, S. Rock, J.-C. Latombe, B. Kennedy, and H. Aghazarian, “Free-Climbing with a Multi-Use Robot,” Proceedings of the 2004 International Symposium on Experimental Robotics, Singapore, June 2004). One link may serve as the base and its position and orientation are specified explicitly. In FIG. 8, a manipulator, or robotic mechanism, may be defined through a link tree. Each individual link may have the form shown in FIG. 7 and moves relative to its parent. The state of the robot may include the position and orientation of the base link (if the base is mobile) and a joint value for all the other links.

The unique robotic control techniques, according to an embodiment of the present invention, may form a core component of a kinematic simulation, which may include a stated system, as described above combined with a configurable control system comprised of at least one or more of a position control system, velocity-control system, an acceleration control system, and a jerk-limiting control system. The control system may be robust enough to be generated automatically, yet flexible enough to give the designer full control over behavior when desired. The position control system, velocity-control system, an acceleration control system and a jerk-limiting control system are described below.

In some embodiments, the velocity-control framework may be implemented as a computer-implemented method for the generating robotic validation system for a robot design or as part of a system for generating the robotic validation system for a robot design.

The core velocity-control framework may be based on the Jacobian equation:

V=J(q)\dot{q}* (1)

wherein V is an m-length vector representation of the motion of an end effectors (for example, linear and angular velocities referenced to points rigidly attached to parts of the robot); q is the vector of joint positions, \dot{q}* is the n-length vector formed by augmenting \dot{q}* with the linear and angular velocity of the base link; and J is the m×n Jacobian, a function of q. When the robotic mechanism is kinematically redundant, the dimension of V may be less than the dimension of q (m<n), and Equation 1 may be under constrained when V is specified. By using V to represent motion of one link relative to another, Equation 1 may support self-connecting mechanisms.

The control framework may calculate joint rates and base motion \dot{q}* that best achieve a desired set of end-effector motions, V, by building on the method described in “On the Embodiment of Velocity-control for Kinematically Redundant Manipulators,” J. D. English and A. A. Maciejewski, IEEE Trans. on Sys., Man, and Cybernetics—Part A: Systems and Humans, vol. 30, no. 3, May 2000, pp. 233-237, which uses a scalar a, a matrix function W(q), and a vector function F(q) to solve for \dot{q}* as follows:

$${\dot{q}}^{*} = {[ \frac{J}{{N}_{J}^{T} W} ]}^{- 1} [ \frac{V}{- α {N}_{J}^{T} F} ] . \qquad ( 2 )$$

wherein N_{J} may be is an n×(n−m) set of vectors that spans the null space of J. That is, JN_{J}=0, and N_{J} has rank (n−m). N_{J} may generally be a function of q. By just changing the values of α, W, and F(q), many new and most established velocity-control techniques may be implemented, including pseudoinverse control (e.g., see “Review of Pseudoinverse Control for Use with Kinematically Redundant Manipulators,” C. A. Klein and C. H. Huang, IEEE Trans. on Sys., Man, and Cybernetics, vol. SMC-13, pp. 245-250, March/April 1983), weighted pseudoinverse control (e.g., see “Robot Manipulability,” K. L. Doty, C. Melchiorri, E. M. Schwartz, and C. Bonivento, IEEE J. Robot. Automat., vol. 11, pp. 462-468, June 1995), augmented Jacobian techniques (e.g., see “Task Space Tracking with Redundant Manipulators,” O. Egeland, IEEE J. Robot. Automat., vol. RA-3, pp. 471-475, October 1987 and “Configuration Control of Redundant Manipulators: Theory and Embodiment,” H. Seraji, IEEE Trans. Robot. Automat., vol. 5, pp. 472-490, August 1989), extended Jacobian techniques (e.g., see “Kinematic Programming Alternatives for Redundant Manipulators,” J. Baillieul, Proc. 1985 IEEE Int. Conf. Robot. Automat., St. Louis, Mo., Mar. 25-28, 1985, pp. 722-728 and “Improved Configuration Control for Redundant Robots,” H. Seraji and R. Colbaugh, J. Robot. Syst., vol. 7, no. 6, pp. 897-928, 1990), and projection methods (e.g., see “Optimal Rate Allocation in Kinematically Redundant Manipulators—The Dual Projection Method,” M. Z. Huang and H. Varma, Proc. 1991 IEEE Int. Conf Robot. and Automat., Philadelphia, Pa., Apr. 24-29, 1988, pp. 28-36 and “An Efficient Gradient Projection Optimization for Manipulators with Multiple Degrees of Redundancy,” H. Zghal, R. V. Dubey, and J. A. Euler, Proc. IEEE 1990 Int. Conf. Robot. and Automat., Cincinnati, Ohio, May 13-18, 1990, pp. 1006-1011). These techniques may be used to optimize criteria such as balance, collision avoidance, joint-limit avoidance, and strength optimization.

V represent the motion of all the robot's end effectors concatenated into a single column. Many types of end effectors may be supported, such as point constraints, frame constraints, joint angle constraints, and center-of-mass constraints. Any number of these different types may be used to define V. It is possible to exchange end-effector descriptions, and thereby change the definition of V, at runtime.

The control system may be organized into an XML-described tree structure that can formally represent the complexity in a realistic control system (complexity that might otherwise be hard coded), and it can provide a method of organization that supports dynamic programming, i.e., the storage of subproblem solutions to prevent duplicate calculation. This dynamic-programming/logical-tree approach may build the W, F, and a parameters used in Equation 2 efficiently from user-defined XML data, allowing detailed algorithms to be constructed.

Velocity-control may be used for placing end effectors as follows: the current pose of an end-effector (location and orientation for a frame end effector, for example) and the desired pose are used to construct an end-effector velocity that, if followed, will give alignment. For point end effectors, the desired velocity of the point may simply be a scalar gain times the difference in position. That is, if p̅ₐ̅ is the actual position and p̅_̅{̅d̅}̅ is the desired position, then the desired velocity, v̅_̅{̅d̅}̅, is given by the following, where kₑ is a positive gain:

v̅_̅{̅d̅}̅=kₑ*(p̅_̅{̅d̅}̅−p̅ₐ̅) (3).

For frame end effectors, every three-dimensional rotation may be expressed as a rotation about a single axis. Let the unit-norm axis of rotation between the actual and desired frames be û and the angle of rotation be θ. Then the desired angular velocity is given by:

ω̅_̅{̅d̅}̅=kₐ*θ*û (4)

where kₐ is a positive gain. This approach may allow the velocity-control system defined by Equation 2 to be used directly for position control.

In some embodiments, a jerk-limiting control framework may also be used in addition to the velocity-control framework. The jerk-limiting control framework may be used without the velocity-control framework. The jerk-limiting control framework may be implemented as a system and/or method for controlling jerk on one or more robotic joints of a robot during motion.

In some embodiments, in determining the jerk-limiting control framework, a first set of variables including one or more variables and a second set of variables containing one or more variables may be used. The first set of variables may include the state of the robot. The state of the robot may include a position and orientation of the base link (if the base is mobile) and a joint value for all the other links. The second set of variables may include at least one or more of the position of a point on a link of the robotic system, position and orientation of the end effector of the robotic system, and the location of the center of gravity of the robot may be considered. The second set of variables may be constrained. The constrained variables may be imposed on one or more variable of the first set of variables. A path for the robot to follow may be generated for all variables. For example, there may be six variables with a robot (e.g., Universal Robots UR10, etc.) mounted to a table.

According to a known jerk-limiting framework, one example of a jerk-limiting control framework may include a joint path. The joint path may represent a function (ƒ(s)), given a scalar value (s), that may return all joint values of a robot moving along a path. Further, the joint path may represent a sequence of joint values at each timestep of a robot traveling along a path. In one embodiment, the joint path may be parameterized on some σ, where σ represents a path position as a function of time and may evolve on the states [σ \dot{σ} \ddot{σ}]^{T} where [symbol] may be the control input. In this example, \dot{σ} is velocity, \ddot{σ} is acceleration, and T is a matrix transpose. A third derivative at a timestep k ( [symbol] ₖ) may be determined and may then be applied at a current timestep. The determined [symbol] ₖ may be used to predict a state at a future timestep. For example, the future timestep may be the timestep that occurs directly after the current timestep. The predicted state may then be used to test if it is possible for the robot to stop without violating any limits though a stopping test. The limits, for example, may include the end effector limits (i.e. velocity, acceleration, jerk). In order to test if it is possible for the robot to stop, the velocity and acceleration may both be equal to zero. Further, it may be required to predict forward in time far enough in order for a stopping action applied to the robot to be completed. If the stopping test succeeds, [symbol] ₖ may be applied to the robotic system of the robot and the results of may be stored. In this example, the robotic system of the robot may accelerate as it progresses along the path. Alternatively, if the robot fails the stopping test, input from a successful stopping test may be applied to the current timestep. In this example, the robotic system of the robot may decelerate as it progresses along the path. (See, L. Messner, H. Gattringer, and H. Bremer, “Efficient Online Computation of Smooth Trajectories Along Geometric Paths for Robotic Manipulators,” Multibody System Dynamics, Robotics and Control, pp. 17-30, 2012).

In one embodiment, according to the present disclosure and as show in FIG. 4, the jerk-limiting control framework may be configured to control jerk of one or more robotic joints of a robot during motion where a first path to be traveled by a robot may be calculated 400 without applying one or more jerk restrictions.

According to this embodiment, in summary, movement by a robot through a path may be approximated. Further, the embodiment may include a starting state, an ending state, and a series of points along a given path. A sub-optimal solution of the jerk may be found, which may induce a path moving along the given series of point from the starting state to the ending state. The number of points may represent a time interval within which the jerk input it applied. A predetermined velocity for the robot to follow along a path may not exceed a user defined value and velocity, acceleration, and jerk limits may be adhered to.

Further, the first path may be based upon, at least in part, a path time parameter. Using a path time parameter may correspond to the time evolution that would happen if there were no joint rate constraints. For example, if a user defines a path time parameter of one second and the velocity is equal to one, the robot may complete the path in one second. Further, in this example, if velocity is reduced to 0.5, the robot may move half as fast along the path and may take two seconds to complete. Alternatively, if the velocity is increased to 2, the robot may move twice as fast along the path and will take 0.5 seconds to complete the path.

In one embodiment, the jerk-limiting control framework of the present disclosure may be carried out as follows. Initially, a nominal joint path (q̅(σ)), where σ is the nominal path time, which is the actual path time of a robot traveling along a path without any jerk limiting on the robot, and q is a continuous time evolution of a real joint path, which represents the actual path of the robot. In the jerk-limiting control framework q, may have the following properties:

$$\begin{matrix}q = \overline{q} ( σ ) & ( 5 ) \\ \dot{q} = {q}^{- ′} \dot{σ} & ( 6 ) \\ \ddot{q} = {\overline{q}}^{″} {\dot{σ}}^{2} + {\overline{q}}^{′} & ( 7 ) \\ = {\overline{q}}^{′′′} {\dot{σ}}^{3} + 3 {\overline{q}}^{″} \ddot{σ} \dot{σ} + {\overline{q}}^{′} & ( 8 ) \\ {\overline{q}}^{′} {=}^{Δ} \frac{dq}{d σ} . & ( 9 )\end{matrix}$$

In Equation 5, as illustrated above, real joint positions of the robot at a current time may be equal to the nominal joint positions of the robot evaluated using the current parameter value (σ). Further, in Equation 6, real joint velocities at a current time may be equal to the nominal joint position derivative with respect to σ multiplied by the current time derivative of the parameter value (\dot{σ}).

In some embodiments, values for q and q′ may be produced at discrete times [σₘ σₘ₊₁ σₘ₊₂ . . . σ_{M}]. Higher order derivatives may be computed via backwards finite differencing, using the following equations:

$$\begin{matrix}{q}_{m}^{″} = \frac{{q}_{m}^{′} - {q}_{m - 1}^{′}}{δ} & ( 10 ) \\ {q}_{m}^{′′′} = \frac{{q}_{m}^{″} - {q}_{m - 1}^{″}}{δ} & ( 11 )\end{matrix}$$

For derivatives at a time between the times calculated using the above equations, linear interpolation may be used. Further, for times beyond the end, t>σ_{M}, the derivatives may be assumed to be zero.

In some embodiments, at the start of each timestep, the first time derivative of the path parameter (\dot{σ}) may be set to the range [0 1], the second time derivative of the path parameter (\ddot{σ}) may have an unlimited range, and a third derivative of the path parameter ( [symbol] ) value may be calculated by applying [symbol] ₘᵢₙ and [symbol] ₘₐₓ to Equation 8, reproduced below for convenience:

[symbol]

=q̅′″\dot{σ}³+3q̅″\ddot{σ}\dot{σ}+q̅′ [symbol] (8).

If the nominal joint position derivative with respect to σ at timestep k (q′ₖ) is equal to zero, then Equation 8 may be irrelevant. As a result of Equation 8 being irrelevant, [symbol] limits may be arbitrarily set to

$$\pm \frac{1}{{δ}^{2}} ,$$

where δ represents a timestep.

Once the initial limits are defined and/or calculated as noted in the above paragraphs, the initial limits may be refined. To refine the initial limits, a stop path may be tested until the stop path test passes or is aborted. Testing the stop path may include at least one or more of calculating an advance profile, calculating a stop profile, and testing the calculated stop profile.

The advance profile may include calculating \dot{σ}ₘₐₓ using the following equation:

\dot{σ}_{c}=+\dot{σ}₀+\ddot{σ}t_{c}+1/2 [symbol] _{min/max}t_{c}² (12),

where t_{c} is the critical time where \dot{σ} reaches its maxima/minima (\dot{σ}_{c}), \dot{σ}₀ is a predetermined value, and \ddot{σ}₀ is a predetermined initial value.

If \dot{σ}_{c} is calculated to be within the predetermined allowable range of [0 1] and the joint position, velocity, and acceleration are within configured limits, the advance profile calculation may succeed and the [symbol] value used may be used to simulate the a state forward one timestep, which is referred to as the advanced state. If \dot{σ}_{c} is calculated to be outside of the predetermined allowable range of [0 1], the advance profile calculation may fail and an advance profile may not be generated. In this case, the stop test may be aborted and a last successful stop profile may be applied instead.

According to an embodiment of the present disclosure, a stop profile may be calculated. The stop profile may include a bang-bang control. For example, the stop profile may be defined to have the form of a bang-bang control, where a first phase may apply a maximum negative [symbol] value and a second phase may apply a maximum [symbol] value. The same equations used to bring the σ state to a stop may also be used to bring it back to a nominal state where \dot{σ} equals 1 and the \ddot{σ} equals zero (\dot{σ}=1, \ddot{σ}=0). The previously calculated advance profile may be used as a starting point for calculating the stop profile. The stop profile may be calculated using the following equations:

$${01}_{} = \frac{1 {\ddot{σ}}_{1}^{2} - {\ddot{σ}}_{0}^{2}}{2 {\dot{σ}}_{1} - {\dot{σ}}_{0}}$$

$${1 f}_{} = \frac{1 {\ddot{σ}}_{f}^{2} - {\ddot{σ}}_{1}^{2}}{2 {\dot{σ}}_{f} - {\dot{σ}}_{1}}$$

$$2 {1 f}_{} ( {\dot{σ}}_{f} - {\dot{σ}}_{1} ) = {\ddot{σ}}_{f}^{2} - {\ddot{σ}}_{1}^{2}$$

$$2 {1 f}_{} {\dot{σ}}_{1} = 2 {\dot{σ}}_{f} {1 f}_{} - {\ddot{σ}}_{f}^{2} + {\ddot{σ}}_{1}^{2}$$

$$\begin{matrix}{\dot{σ}}_{1} = ( 2 {\dot{σ}}_{f} {1 f}_{} - {\ddot{σ}}_{f}^{2} + {\ddot{σ}}_{1}^{2} ) & ( 13 ) \\ {01}_{} = \frac{1}{2} \frac{{\ddot{σ}}_{1}^{2} - {\ddot{σ}}_{0}^{2}}{ ( 2 {\dot{σ}}_{f} {1 f}_{} - {\ddot{σ}}_{f}^{2} + {\ddot{σ}}_{1}^{2} ) - {\dot{σ}}_{0}} & \\ ( {\dot{σ}}_{f} {1 f}_{} - {\ddot{σ}}_{f}^{2} + {\ddot{σ}}_{1}^{2} - 2 {\dot{σ}}_{0} {1 f}_{} ) = {\ddot{σ}}_{1}^{2} - {\ddot{σ}}_{0}^{2} & \\ 2 ( {\dot{σ}}_{f} - {\dot{σ}}_{0} ) {01}_{} - {\ddot{σ}}_{f}^{2} + {\ddot{σ}}_{0}^{2} = ( 1 - ) {\ddot{σ}}_{1}^{2} & ( 14 ) \\ 2 ( {\dot{σ}}_{f} - {\dot{σ}}_{0} ) {01}_{} + {\ddot{σ}}_{0}^{2} - {\ddot{σ}}_{1}^{2} = ( {\ddot{σ}}_{f}^{2} - {\ddot{σ}}_{1}^{2} ) . & ( 15 )\end{matrix}$$

In Equations 13-15, the current a state is defined as having an initial values [⋅ \dot{σ}₀ \ddot{σ}₀], an intermediate state having unknown values [⋅ \dot{σ}₁ \ddot{σ}₁], and a goal (i.e. final) state of [⋅ \dot{σ}_{f} \ddot{σ}_{f}], where the zero-order value σ is irrelevant. Further, values for [symbol] ₀₁ and [symbol] _{1f} may be defined as the values applied during the first and second phases, respectively, where [symbol] ₀₁ is the value of [symbol] applied during a first phase (i.e. from the initial state to the intermediate state) and [symbol] _{1f} is the value of [symbol] applied during a second phase (i.e. from the intermediate state to the goal state). For example, if the robotic system of the robot is decelerating to a stop, [symbol] ₀₁ is the maximum negative value and [symbol] _{1f} is the maximum positive value. If accelerating, swap those two. Alternatively, if the robotic system of the robot is accelerating, [symbol] ₀₁ is the maximum positive value and [symbol] _{1f} is the maximum negative value.

Further, in Equations 13-15, the goal may be to determine the intermediate state. The intermediate state may indicate how long the respective [symbol] ₀₁ and [symbol] _{1f} values need to be applied for. According to Equation 14, \ddot{σ}₁ may be solved for first, where \ddot{σ}₁ is the value of \ddot{σ} at the intermediate state. As a result, Equation 15 may be solved for the \dot{σ}₁, where \dot{σ}₁ is the value of \dot{σ} at the intermediate state. If the calculated \ddot{σ}₁ is outside the allowed range, \ddot{σ}₁ may be, alternatively, assigned to a respective limit. The allowed range of \ddot{σ}₁ may initially be unlimited, but may be tightened at each timestep. For example, if the calculated value of \ddot{σ}₁ is greater than a maximum allowed value, an upper limit of \ddot{σ}₁ may be used where \ddot{σ}₁ is equal to \ddot{σ}ₘₐₓ. Equation 15 may be solved for [symbol] _{1f} using the relevant limit assigned to \ddot{σ}₁. Alternatively, if \dot{σ}₁ is outside the allowable range of [0 1], the goal state is checked to see if it may be possible to reach the goal state via a single phase using the following equations:

$$\begin{matrix}{\ddot{σ}}_{f} = {\ddot{σ}}_{0} + & \\ {t}_{p} = {\ddot{σ}}_{f} - {\ddot{σ}}_{0} & \\ \begin{matrix}{\dot{σ}}_{f} = {\dot{σ}}_{0} + {\ddot{σ}}_{0} {t}_{p} + \frac{1}{2} {t}_{p}^{2} \\ = {\dot{σ}}_{0} + {\ddot{σ}}_{0} {t}_{p} + \frac{1}{2} ( {\ddot{σ}}_{f} - {\ddot{σ}}_{0} ) {t}_{p} \\ = {\dot{σ}}_{0} + \frac{1}{2} ( {\ddot{σ}}_{0} + {\ddot{σ}}_{f} ) {t}_{p}\end{matrix} & \\ {t}_{p} = 2 \frac{{\dot{σ}}_{f} - {\dot{σ}}_{0}}{{\ddot{σ}}_{f} + {\ddot{σ}}_{0}} & ( 16 ) \\ \begin{matrix}= \frac{1}{2} \frac{( {\ddot{σ}}_{f} - {\ddot{σ}}_{0} ) ( {\ddot{σ}}_{f} + {\ddot{σ}}_{0} )}{{\dot{σ}}_{f} - {\dot{σ}}_{0}} \\ = \frac{1}{2} \frac{{\ddot{σ}}_{f}^{2} - {\ddot{σ}}_{0}^{2}}{{\dot{σ}}_{f} - {\dot{σ}}_{0}}\end{matrix} . & ( 17 )\end{matrix}$$

The single phase may be reached by moving from the initial state to the goal state by applying a constant \ddot{σ} the entire time, as opposed to applying two separate values of \ddot{σ} in two phases. In Equation 16, tₚ is how long [symbol] is applied for. Equations 16 and 17 may be solved for tₚ and [symbol] respectively. If tₚ is greater than zero (tₚ>0) and [symbol] is within the allowed range, the values of tₚ and [symbol] may be used, respectively. If tₚ is less than zero (tₚ<0) and [symbol] is not within the allowed range, stop profile generation may fail.

However, it may need to be determined if it is possible to avoid violating a \dot{σ} limit. For example, if the absolute value of \ddot{σ}₀ (i.e. |\ddot{σ}₀|) is large, it may need to be determined if it is possible to avoid \ddot{σ}₁ drifting outside the allow range of [0 1] while still respecting the [symbol] limits. The following equations may be used to determine if it is possible to avoid violating a \dot{σ} limit:

$$\begin{matrix}{t}_{c} = \frac{- {\ddot{σ}}_{0}}{{min \text{/} max}_{}} & ( 18 ) \\ {\dot{σ}}_{c} = {\dot{σ}}_{0} + {\ddot{σ}}_{0} {t}_{c} + \frac{1}{2} {min \text{/} max}_{} {t}_{c}^{2} . & ( 19 )\end{matrix}$$

In Equations 18-19, t_{c} is the critical time where \dot{σ} reaches its maxima/minima \dot{σ}_{c}. If \dot{σ}_{c} is outside the allowable range, the stop profile generation may fail. The allowable range of \dot{σ}_{c} may initially be [0 1], but it may be possible for the maximum value of \dot{σ}_{c} to be reduced to less than 1 while the minimum of \dot{σ}_{c} never increases above 0.

As a result of the above calculations, a successful stop profile may be generated. Alternatively, if any calculation within the stop profile fails, the calculation may be aborted. As a result, a last successful stop profile may be applied instead to the stop path.

The successful stop profile may then be tested. As discussed above, the successful stop profile may adhere to one or more of the current state limits. However, it may need to be determined if one or more of the state limits are tight enough (i.e. the minimum value of the state limits are not too negative and the maximum values are not too positive) to avoid violation of one or more of the joint state limits. In order to determine if the state limits are or are not violated, one or more states along the calculated successful stop profile may be tested. If one or more of the current state limits are found to be violated during testing, the σ state limits may be updated accordingly.

In testing the one or more states along the calculated successful stop profile, the \dot{σ} value, \ddot{σ} value, and/or [symbol] values may be tested. If one or more of the tests result in a failure, the σ state limits may be updated and may be used to recalculate the advance profile. If the testing passes as a whole, the calculated successful stop profile may be saved and a “success” status report may be reported.

In calculating one or more velocity values (\dot{q}) of one or more joints of the robot, current σ state and path state (i.e. set of joint angles) may be applied to Equation 6, reproduced below for convenience, to calculate \dot{q}:

\dot{q}=q̅\dot{σ} (6).

If the result of Equation 6 results \dot{σ} limit that violates the predetermined range [0 1], the respective limit may be used to back calculate an acceptable \dot{σ} value. The σ state limits may then be updated using the respective limit.

In testing the \ddot{σ} value, the current \ddot{q} state and path state may be applied to Equation 7 to calculate \ddot{q}, reproduced below for convenience:

\ddot{q}=q̅″²+q̅′\ddot{σ} (7).

In addition to calculating \ddot{q} from Equation 7, ensuring \ddot{σ}=0 may be an additional determination, since the same σ state limits are used throughout the entire stop profile, which may need both positive and negative \ddot{σ}, as shown in the equation below:

∝\ddot{q}ₘᵢₙ≤q̅′\dot{σ}²≤∝\ddot{q}ₘₐₓ (20).

In Equation 20, ∝∈(0 1) is a tuning factor to ensure there may be some authority left for a in the equation. The turning factor may be a user configurable input to adjust specific behaviors of the calculations. According to Equation 20, if \ddot{q} violates a limit (i.e. a user configured joint acceleration limit) or if Equation 20 is violated, testing the \ddot{σ} value may result in a failure. If the test fails, the \dot{σ} limits may be adjusted in view of Equation 20. The \ddot{σ} limits may be adjusted according to Equation 7.

In testing the [symbol] value, ensuring that [symbol] =0 is always a valid option may be determined, since positive and negative [symbol] values may need to be applied. In order to test the calculated [symbol] value, Equation 8, reproduced below for convenience, may be used to calculate [symbol] (i.e. joint jerk):

[symbol]

=q̅′41 \dot{σ}³+3q̅″\ddot{σ}\dot{σ}+q̅′ [symbol] (8).

After [symbol] is calculated from Equation 8, the following condition may need to be met:

β [symbol] ₘᵢₙ≤q̅″′σ³+3q̅″\ddot{σ}\dot{σ}≤β [symbol] ₘₐₓ (21).

In Equation 21, β∈(0 1) is a tuning factor to ensure the [symbol] value retains some control authority in the equation. If Equation 21 is violated, the following heuristic may be used:

$$\begin{matrix}{β}_{1} {=}^{Δ} \frac{\vert {\overline{q}}^{′′′} \vert}{\vert {\overline{q}}^{′′′} \vert + \vert {\overline{q}}^{″} \vert} β & \\ {β}_{2} {=}^{Δ} \frac{\vert {\overline{q}}^{″} \vert}{\vert {\overline{q}}^{′′′} \vert + \vert {\overline{q}}^{″} \vert} β & \\ {β}_{1} {min}_{} \leq {\overline{q}}^{′′′} {\dot{σ}}^{3} \leq {β}_{1} {max}_{} & ( 22 ) \\ {β}_{2} {min}_{} \leq 3 {\overline{q}}^{″} \ddot{σ} \dot{σ} \leq {β}_{2} {max}_{} . & ( 23 )\end{matrix}$$

According to Equations 22-23, a desired range for the monomials may be created by setting tuning values for β₁ and β₂. If equation 22 is violated (i.e. originally estimated limits of \dot{σ} are too wide), the respective \dot{σ} limits) are adjusted accordingly. Similarly, if Equation 24 is violated (i.e. originally estimated limits of \ddot{σ} are too wide), the \ddot{σ} limit(s) may be adjusted accordingly. Further, individual monomials limits may be applied to significantly reduce a maximum stop profile length, in addition to the combined limits of Equation 21, using the following equations:

γ₁ [symbol] ₘᵢₙ≤q̅′″\dot{σ}³≤γ₁ [symbol] ₘₐₓ (24)

γ₂ [symbol] ₘᵢₙ≤3q̅″\ddot{σ}\dot{σ}≤γ₂ [symbol] ₘₐₓ (25)

In Equations 24-25 above, γ₁, γ₂ ∈[0 1] are pure tuning parameters. For example, the tuning parameters may allow a maximum stop profile length to be reduced from 2.0 seconds to 0.18 seconds. By reducing the maximum stop profile length, fewer timesteps may be required when simulating ahead.

Further, the first path may be generated in real time over one or more timesteps by considering at least one of velocity, acceleration, robotic arm link configuration, one or more obstacles in the environment, and energy consumption. The first path may be generated in real time by including at least one constraint on point position, frame orientation, pointing direction, center of mass position, or linear or angular momentum.

Additionally, according this embodiment of the present disclosure, one or more jerk restrictions may be applied 402 to the first path after the first path has been calculated 400 to generate a second path. The second path may be generated using one or more of Equations 1-25, as discussed in the above paragraphs. The second path may be generated using any of the features and/or limitations discussed in the above paragraphs. The one or more jerk restrictions may include a jerk value below a predetermined value. Further, applying the one or more jerk restrictions may be configured to prevent vibration of one or more robotic joints or the end effector of a robot.

Generating the second path may include calculating and testing a calculated stop profile, as described the paragraphs above. Specifically, once the testing of the calculated stop profile is complete, as described in the paragraphs above, a success or failure message may be provided. If the testing of the calculated stop profile reports a success, the [symbol] value may be applied to the advanced phase calculated above where the σ state becomes the advanced state and the second path may be generated. If the testing of the calculated stop profile report a failure, [symbol] may be applied at the start of the calculated stop profile and the stop profile may be updated to “start” a next timestep and the second path may be generated.

Once [symbol] is applied and the second path is generated, a velocity value may be generated. The velocity may represent how fast real time moves relative to a desired path time. The velocity value may represent a speed along the path the robot travels. Further, the calculation of the second path may result in an approximation of the second path based on, at least in part, the first path and the jerk constrains that may be applied, as discussed above.

The second path may be configured to move an end effector or a tool of the robot along the second path in a velocity less than a predetermined value. The predetermined value may be defined by a user. For example, the predetermined value may be at least greater than or equal to zero and less than or equal to one. In this example, a velocity equal to 1 is preferred. Additionally, this example provides a velocity that satisfies all end effector constraints on at least one of velocity, acceleration, and jerk. If, for example, the velocity was greater than one, one or more of the end effector constrains (i.e. velocity, acceleration, jerk) may be violated. Further, the predetermined value may allow for a fixed speed of the end effector of the robot.

Further, the second path may be configured to react to sudden changes in the path without advanced knowledge. For example, the second path may be configured to allow for at least one of path deviation and limit violation.

Further, in accordance with this embodiment of the present disclosure, robotic joints of the robot may be part of robotic hardware, wherein the robotic hardware may be at least one of a mobile robot, a fixed base articulated serial manipulator, a moving base articulated serial manipulator, a fixed base articulated robot with branching links, and a moving base articulated robot with branching links.

Additionally, in accordance with this embodiment of the present disclosure, the jerk-limiting control framework may be implemented to limit joint jerk of a robotic system in end-effector (EE).

A simulation may be scripted, with desired end-effector positions configured off line, or interactive, with the end-effector paths controllable in real time by the user through a PC mouse. A scripted simulation may enable the quick creation of animations and movies for observing and conveying behavior. Interactive simulations may provide hands-on understanding of robotic capabilities and provide real-time interactive demonstrations.

According to an embodiment of the present invention, a dynamic simulation may include all the capability of a kinematic simulation plus numerical integration of Newton's and Euler's dynamic equations for moving parts. Articulated dynamics, impact dynamics, and the dynamics of the motor controllers may also be included.

For articulated dynamics, two methods, e.g., may be used: the Articulated Body Inertia Algorithm (e.g., see M. W. Walker and D. E. Orin, “Efficient Dynamic Computer Simulation of Robotic Mechanisms,” Journal of Dynamic Systems, Measurement, and Control, 104, 205-211, 1982, and A. Fijany and A. K. Bejczy, “An Efficient Algorithm for Computation of Manipulator Inertia Matrix,” Journal of Robotic Systems, 7(1), 57-80, 1990), and the Composite Rigid-Body Inertia Algorithm (e.g., see R. Featherstone, Robot Dynamics Algorithms, Kluwer Academic Publishers, Boston, 1987 and R. Featherstone and D. Orin, Proc. IEEE Conf. Robotics and Automation, San Francisco, Calif., 2000, pp. 826-834).

The Order(N), for N links, Articulated Body Inertia algorithm may be better suited for very large robots, while the Order(N3) Composite Rigid-Body Inertia algorithm may be better suited for simpler robots and passive environmental objects. Both methods may be numerically integrated using a configurable algorithm that relies on predictor and corrector integration algorithms, which are ideally suited for this application (e.g., see “Numerical Integration and Digital-Model Updates in the AIM-9X Simulation,” J. D. English and J. A. Bacon, Second Annual Systems Engineering Symposium, Raytheon, Waltham, Mass., June 1998).

According to an embodiment of the present invention, a parametric study may take discrete steps through changes in initial state or system parameters and tabulate simulation results. The parametric study may allow the user to easily change in fixed increments initial configurations, control parameters, surface properties, weights, lengths, end effectors, motor torques, and actuator effectiveness, and tabulate the results of those changes. Results may include (but may not be limited to) measures of sensor saturation, visibility, speed, mobility, balance, end-effector placement, and/or manipulation.

The design of the parametric study may include: 1) representation changes to the initial state and system, and 2) a representation of the results of the simulation runs. For each of these, there may be two levels of configuration, one comprehensive and one simplified.

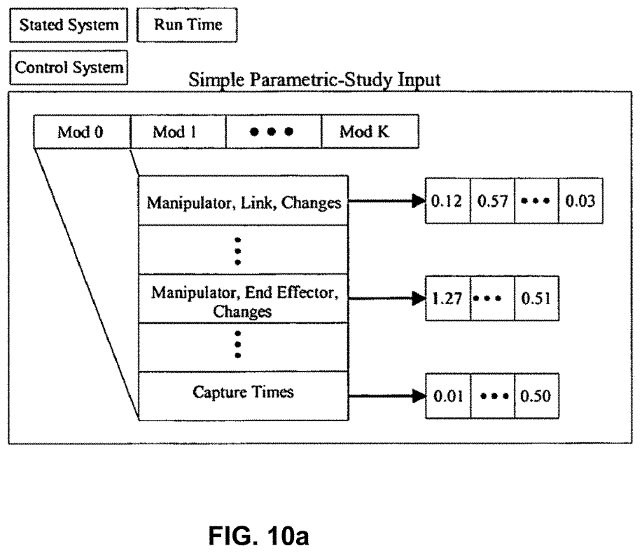

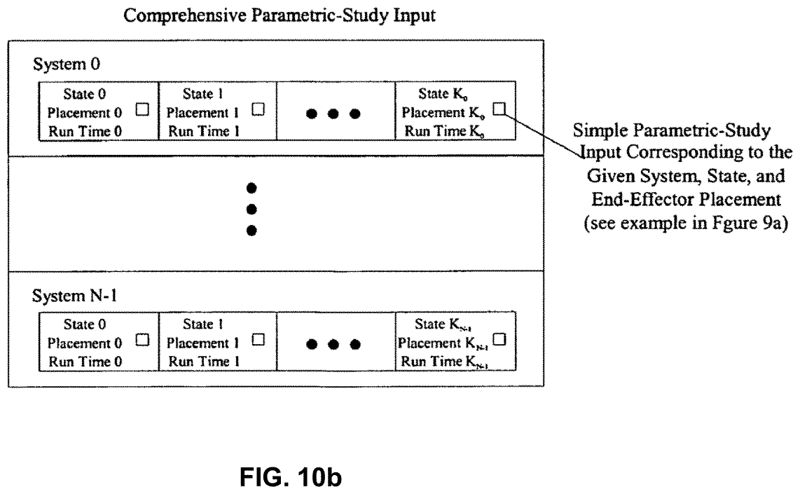

The simplified approach may use one stated system combined with a collection of sets of changes. Each element in the collection may itself be a collection of data sets that may include 1) the manipulator index, 2) the starting link, and 3) a vector of new values for the joint variables. When the specified link is the base link, the first seven values may represent the position and orientation (through a quaternion) of the base. This is illustrated in FIG. 10a.

In FIG. 10a, the simple form of input to the parametric study may use a reference stated system, control system, and run time. It may apply a vector of modifications to these reference values. Each modification may be composed of multiple data sets. The first set may hold state changes. The second set may hold end-effector position changes. The third set may be a group of capture times and the output is saved for each capture time.

The comprehensive approach to configuring a parametric study may represent each step in the study by a system, state, end-effector placement, and run time. With this, it may be possible to change at one extreme just one joint value and at the other extreme the complete system, state, and desired-positioning description. The comprehensive input to a parametric study may be organized as shown in FIG. 10b, wherein the comprehensive form of the input to the parametric study may use any number of system changes combined with any number of state, placement, and run-time changes. In FIG. 10b, each combination has a corresponding simple parametric study (matching that shown in FIG. 10a).

The output of each parametric study may be either a complete state or a specified subset of the state. The complete state may be comprehensive, while the subset may be a simplified form that uses less memory for storage. A subset may be specified through a vector of manipulator, starting link, end-effector, and/or number of values. This may allow any part of either the explicit state or the end-effector positions/orientations to be captured. More complex functions of the output values may be post-processed (see post-processing tool 208 in FIG. 2), using, for example, MATLAB, MATHEMATICA, or EXCEL.

Furthermore, according to an embodiment of the present invention, a Monte Carlo study may be performed by selecting random initial values for the system and state parameters described above for the parametric study. In addition to random initial values, noise may be input to sensor and actuator models. The noise models for the sensors and actuators may be built into the classes that define them. The initial conditions for the system state may be selected based on a set of probability density functions. The selected values for a time sequence of other parameters, e.g., desired end-effector positions may also be set using probability density functions.

According to a further embodiment of the present invention, the parameter optimization study may enable the optimization of system parameters based on criteria defined through Monte Carlo studies. It may use stochastic optimization techniques, which do not require smooth, or even continuous, metrics, for optimization. This is a powerful approach built on the best tools used for analysis (Monte Carlo simulation and stochastic optimization), specifically tailored to the needs of robot designers (contrasting with more theoretical techniques, e.g., see H. Lipson, and J. B. Pollack, “Automatic Design and Manufacture of Robotic Lifeforms”, Nature 406, 974-978, 2000). The results of a parameter optimization study may be new robotic parameters, such as length, mass motor torque, or sensor placement, which will be communicated back into the design process for review and used in the next design cycle.

Moreover, the parameter optimization study may leverage parallel processing. Algorithms and software for parameter optimization studies that may be separated, where possible, into independent pieces may either be executed in sequence on a single-core processor or in parallel on multiple processors or cores, according to an embodiment of the present invention.

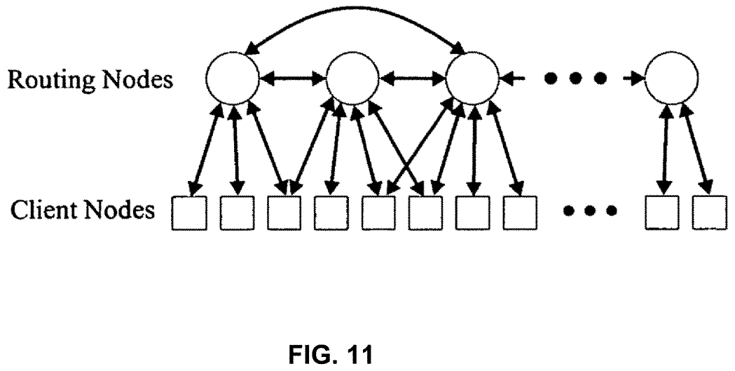

According to a further embodiment of the present invention, a system for network communications may be used. This system may be specifically tailored to the exchange of robotic design and validation information through the XML language, allowing for a networked validation system that is easy to use yet robust. The organization that was shown in FIG. 5 may supports both client-server and peer-to-peer architectures. If there is just one routing node, it may play the role of a server. If there are multiple routing nodes, they may exchange information and hand-off client interfaces to form a robust infrastructure of connections, as shown in FIG. 11, wherein the architecture may support peer-to-peer organization, with connections between clients routed through a network of routing nodes, which may allow selected components to organize communication as shown in FIG. 5.

For two client nodes to exchange information, they must discover a common routing node. Over a LAN (local area network), client nodes may find server nodes using UDP (user datagram protocol) broadcast. Broadcast addresses may exist at both the hardware and IP (internet protocol) level. On an IP network, broadcasts may be addressed to the four-byte IP address 255.255.255.255, allowing the message to reach every computer on a physical network (without passing through routers).

The client nodes may send periodic messages seeking LAN routing nodes in this way. Each LAN routing node may respond to the broadcast messages to inform the client node of its presence. After this acknowledgement, a client node may request information from the LAN routing node at any time, including identification of other LAN client nodes and of WAN (wide area network) routing nodes. For communicating information on nodes, a set of string-string, string-float, and string-integer maps may be used, described through the XML. This generic approach may allow new information to be easily incorporated and consumed.

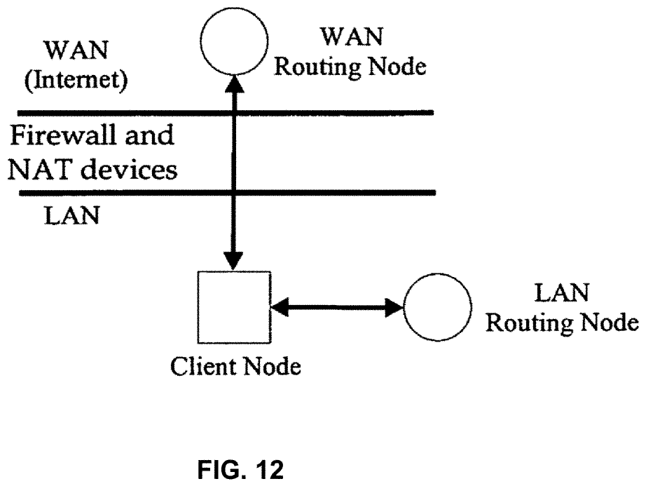

Moreover, networked operation may allow interactive engineering collaboration, support engineers wanting to run validation software on fast remote computers while working on a desktop, enable interactive demonstrations to managers or other non-engineers, and support parallelization of simulation runs. To enable optimal performance in both LAN and WAN (public Internet) environments, each client may maintain contact with LAN and WAN routing nodes. The LAN routing node may be inside the most local NAT (see K. Egevang and P. Francis, “The IP Network Address Translator (NAT)”, RFC 1631, IETF, May 1994) or firewall, and the WAN routing node will be outside the farthest NAT or firewall. Client nodes needing to communicate with other client nodes that are between the nearest and farthest NAT devices or firewalls may communicate in WAN mode. This is illustrated in FIG. 12, wherein each client may maintain both a primary LAN routing node and a primary WAN routing node. This may allow high-performance LAN operation, while providing a firewall and NAT (Network Address Translator) friendly design for the Internet communication. The client and routing nodes may interact in the validation system as shown in FIG. 5

Furthermore, determination of whether a client node is behind a firewall may be made using an approach related to the Simple Traversal of UDP Through NATs (STUN) protocol (see J. Rosenberg, J. Weinberger, C. Huitema, and R. Mahy, “STUN: Simple Traversal of User Datagram Protocol (UDP) through Network Address Translators (NATs),” RFC 3489, IETF, March 2003) developed by the Internet Engineering Task Force (IETF). The STUN protocol may allow any STUN client to communicate with a STUN server on the public Internet to determine if it is behind a NAT and what type of NAT it is.

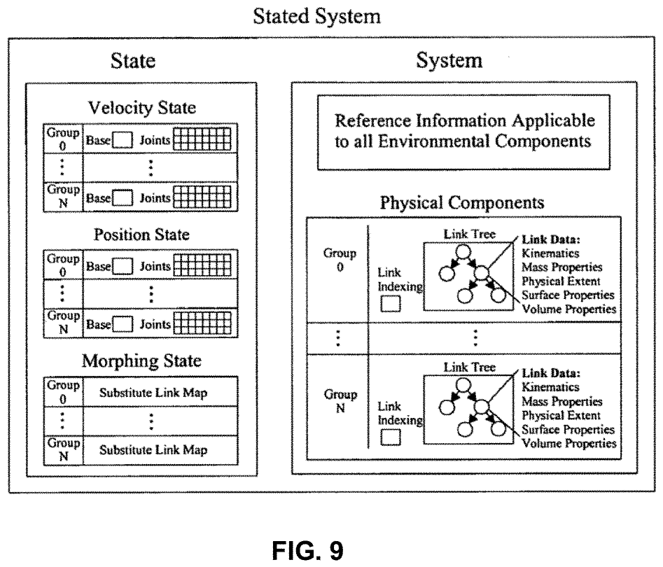

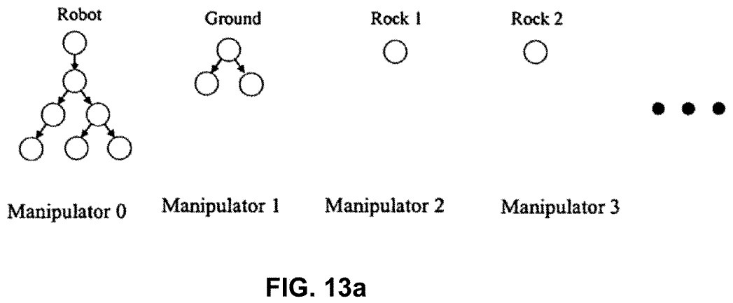

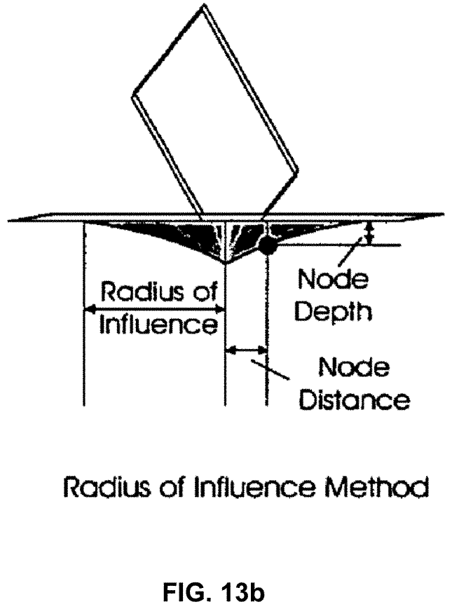

Dynamic simulation of terrain is computationally expensive, and according to a further embodiment of the present invention, different environment configurations may be used in a variety of deformation models based on the level of fidelity required for each component. In addition to the robot, segments of terrain may be modeled as independent manipulator objects, as illustrated in FIG. 13a Terrain features may be separated into links and shapes. The most common shape type may be a polyhedron, with each face having a unique surface property. The deformation architecture may use this approach with the FIG. 9 framework, where each link in the system may be deformed using a morphing state. In FIG. 13a, in the terrain simulation, not just the robotic mechanism, but all components of the terrain, including multiple segments of ground and independently moving rocks, may be modeled as manipulators. This may support maximum realism and optimal selection of algorithms for simulating interactions.

For example, two deformation methods for terrain-robot interaction modeling may be used. The first may be the radius of influence method, which offers good runtime performance (<1 ms processor time per timestep on PC hardware using a moderate mesh size) for elastic interactions. The radius of influence method may be demonstrated in FIG. 13b. It may work as follows: first a penetration vector may be found, representing the location of an impinging foot or wheel with the ground surface. A highly connected data structure may be used to find all nodes lying within the radius of influence, a configurable parameter. For each node, the depth in the direction of the penetration vector may have a magnitude that is a function of the node distance from the impact center and tends toward zero for more distant nodes. This technique may be well suited for simulating the flexibility of robot parts touching terrain.

The second method which may be used is the gridded compliance using a uniform surface grid, as discussed by R. W. Sumner, J. F. O'Brien, and J. K. Hodgins in “Animating Sand, Mud, and Snow,” Computer Graphics Forum, vol. 18, no. 1, 1999. This is well suited for simulating soil interactions (e.g., with sand or stiff terrain). Each cell in the grid may be treated independently, and force and movement may be calculated as properties of the impinging depth and soil properties. The soil properties may be established as those described by X. Li and J. M. Moshell, in “Modeling Soil: Realtime Dynamic Models for Soil Slippage and Manipulation,” Proceedings of the 20th Annual Conf. on Comp. Graphics and Interactive Techniques, pp. 361-368, 1993 and extended by C. Grand, F. B. Amar, P. Bidaud, and G. Andrade, in “A Simulation System for Behavior Evaluation of Off-Road Mobile Robots,” Proceedings of the CLAWAR 2001 Conference, pp. 307-314, 2001.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A computer-implemented method for controlling jerk on one or more robotic joints of a robot during motion comprising:
calculating a first path to be traveled by a robot without applying one or more jerk restrictions; and
applying one or more jerk restrictions to the first path after the first path has been calculated to generate a second path.

2. The computer-implemented method of claim 1, wherein the second path is configured to move an end effector or a tool of the robot along the second path in a velocity less than a predetermined value.

3. The computer-implemented method of claim 1, wherein the first path is based upon, at least in part, a path time parameter.

4. The computer-implemented method of claim 2, wherein the predetermined value is defined by a user.

5. The computer-implemented method of claim 1, wherein the first path is generated in real time over one or more timesteps by considering at least one of velocity, acceleration, robotic arm link configuration, one or more obstacles in the environment, and energy consumption.

6. The computer-implemented method of claim 1, wherein the first path is generated in real time by including at least one constraint on point position, frame orientation, pointing direction, center of mass position, or linear or angular momentum.

7. The computer-implemented method of claim 1, wherein the one or more jerk restrictions include a jerk value below a predetermined value.

8. The computer-implemented method of claim 1, wherein generating the second path further comprises calculating and testing a stop profile.

9. The computer-implemented method of claim 1, wherein applying the one or more jerk restrictions are configured to prevent vibration of one or more robotic joints or an end effector of a robot.

10. The computer-implemented method of claim 1, wherein one or more robotic joints of the robot are part of robotic hardware, wherein the robotic hardware may be at least one of a mobile robot, a fixed base articulated serial manipulator, a moving base articulated serial manipulator, a fixed base articulated robot with branching links, and a moving base articulated robot with branching links.

11. A computing system including a processor and a memory system configured to perform operations comprising:
calculating a first path to be traveled by a robot without applying one or more jerk restrictions; and
applying one or more jerk restrictions to the first path after the first path has been calculated to generate a second path.

12. The computing system of claim 11, wherein the second path is configured to move an end effector or a tool of the robot along the second path in a velocity less than a predetermined value.

13. The computing system of claim 11, wherein the first path is based upon, at least in part, a path time parameter.

14. The computing system of claim 11, wherein the first path is generated in real time over one or more timesteps by considering at least one of velocity, acceleration, robotic arm link configuration, one or more obstacles in the environment, and energy consumption.

15. The computing system of claim 11, wherein the first path is generated in real time by including at least one constraint on point position, frame orientation, pointing direction, center of mass position, or linear or angular momentum.

16. The computing system of claim 11, wherein the one or more jerk restrictions include a jerk value below a predetermined value.

17. The computing system of claim 11, wherein generating the second path further comprises calculating and testing a stop profile.

18. A computer program product comprising a non-transitory computer readable storage medium having a plurality of instructions stored thereon, which, when executed by a processor, cause the processor to perform operations including:
calculating a first path to be traveled by a robot without applying one or more jerk restrictions; and
applying one or more jerk restrictions to the first path after the first path has been calculated to generate a second path.

19. The computer program product of claim 18, wherein the second path is configured to move an end effector or a tool of the robot along the second path in a velocity less than a predetermined value.

20. The computer program product of claim 18, wherein the first path is based upon, at least in part, a path time parameter.
